(19) United States
(12) Patent Application Publication
(10) Pub. No.: US 2024/0354612 A1
(43) Pub. Date: Oct. 24, 2024

(54) Caching Matrix Representations of Repeated Quantum Gates

(71) Applicant: Dell Products L.P., Round Rock, TX (US)

(72) Inventors: Brendan Burns HEALY, Haddonfield, NJ (US); Benjamin E. SANTAUS, Somerville, MA (US)

(21) Appl. No.: 18/345,472

(22) Filed: Jun. 30, 2023

Related U.S. Application Data
(60) Provisional application No. 63/383,327, filed on Nov. 11, 2022.

(51) Int. Cl. G06N 10/20; G06F 17/16

(52) U.S. Cl. CPC G06N 10/20; G06F 17/16

(57) ABSTRACT

Replacing a sequence of gates with a replacement matrix. A quantum circuit may include a series of gates that includes a sequence of gates that is repeated within the series or in the quantum circuit. The sequence of gates is computed to generate a replacement matrix. The sequence of gates is then replaced with the replacement matrix. The replacement matrix improves performance by reducing the number of operations that would otherwise be required. The replacement matrix can be cached and allows the circuit to be executed locally, remotely, or both. The cached replacement matrix can be used in other quantum circuits that include the same sequence of gates represented by the replacement matrix.

### FIELD OF THE INVENTION

Embodiments of the present invention generally relate to quantum computing and to orchestrating quantum workloads. More particularly, at least some embodiments of the invention relate to systems, hardware, software, computer-readable media, and methods for caching matrix representations of repeated quantum gates.

### BACKGROUND

Executing quantum circuits in quantum computing systems can be both complicated and time consuming for a variety of different reasons. For example, the quantum circuit may be too large for available quantum hardware and may need to be cut. Further, even if the necessary quantum hardware exists, the quantum circuit may need to wait until the resources are free. There are also problems associated with simulated quantum computing systems. As the complexity of a quantum circuit increases (e.g., more qubits required), the amount of resources required to execute the quantum circuit in the simulated quantum computing system increases exponentially. These issues complicate the ability to effectively and efficiently use quantum computing systems, whether real or simulated.

The execution of quantum circuits in simulated quantum computing systems (quantum simulators) is often achieved using linear algebra. The linear algebra model of quantum mechanics is used to predict and explain the action or operation of quantum systems. As such, the way quantum simulators work (apart from measurement) is to perform complex linear algebra operations, often matrix-matrix operations, to transform qubits from an input state to an output state.

Matrix operations, especially high dimensional matrix operations, are resource intensive. As a result, most computers will have a limit on the complexity (measured in qubits) of quantum simulation that can be modeled. Even with GPU (Graphic Processing Unit) acceleration, most machines will begin to struggle with circuits around 30 qubits, which for practical purposes is severely limiting, given that real QPUs are capable of providing more qubits. As a result, any advantage in quantum simulation can lead to significant improvement in runtime and to a reduction of required resources.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of orchestrating the execution of quantum jobs and of executing quantum jobs;

FIG. 1B discloses aspects of generating custom gates or replacement matrices;

FIG. 1C discloses aspects of providing a caching service in the context of executing a quantum job;

FIG. 2 discloses additional aspects of executing a quantum job in a manner that accounts for generating custom gates or replacement matrices;

FIG. 3A discloses aspects of caching matrix representations of repeated quantum gates;

FIG. 3B discloses additional aspects of caching matrix representations of quantum gates;

FIG. 4 discloses aspects of caching matrix representations and executing quantum circuits locally and/or remotely;

FIG. 5 discloses aspects of improving the performance of quantum simulation;

FIG. 6 discloses aspects of applying a gate or a replacement matrix to a different set of qubits or a different order of qubits; and

FIG. 7 discloses aspects of executing a quantum circuit in a quantum simulator.

### DETAILED DESCRIPTION OF SOME EXAMPLE EMBODIMENTS

Embodiments of the present invention generally relate to quantum systems and related quantum operations. More particularly, at least some embodiments of the invention relate to systems, hardware, software, computer-readable media, and methods for orchestrating quantum workloads, which may include quantum job(s) or circuit(s). Quantum workloads or, more specifically, quantum circuits may be executed in quantum simulators (e.g., virtual quantum systems—vQPUs operating in classical computing systems (e.g., processors, memory)) or quantum hardware (real—QPU) quantum computing systems.

Embodiments of the invention relate to reducing the computational burden of simulating quantum circuits in classical computing systems. Quantum simulation, as used herein, refers to by way of example only, emulating the actions and output of a quantum computing system (e.g., a hardware QPU).

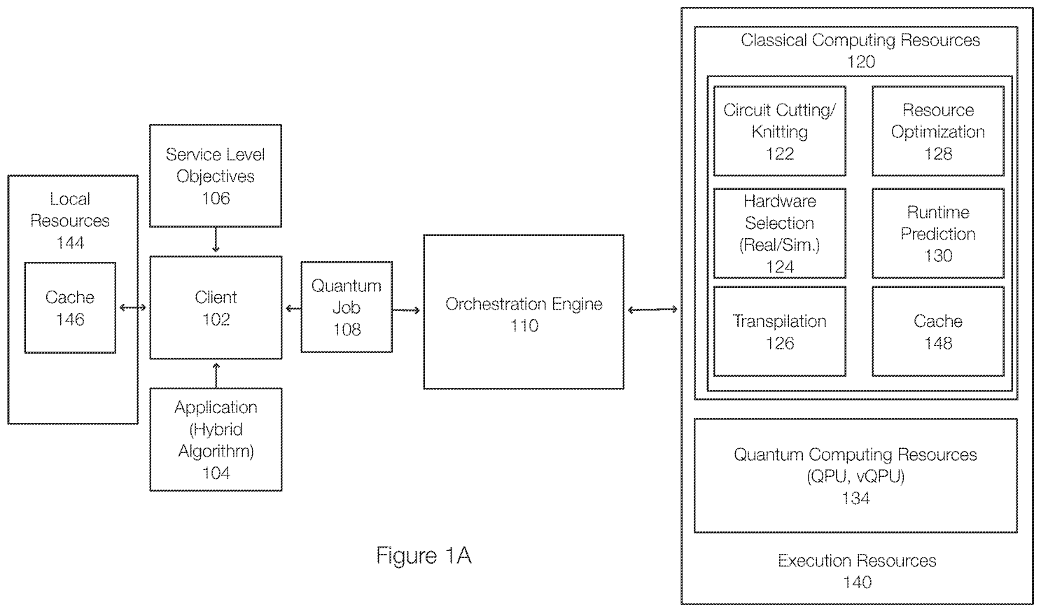

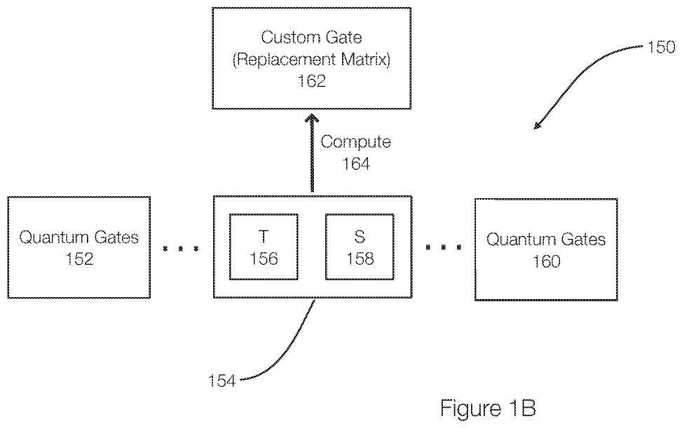

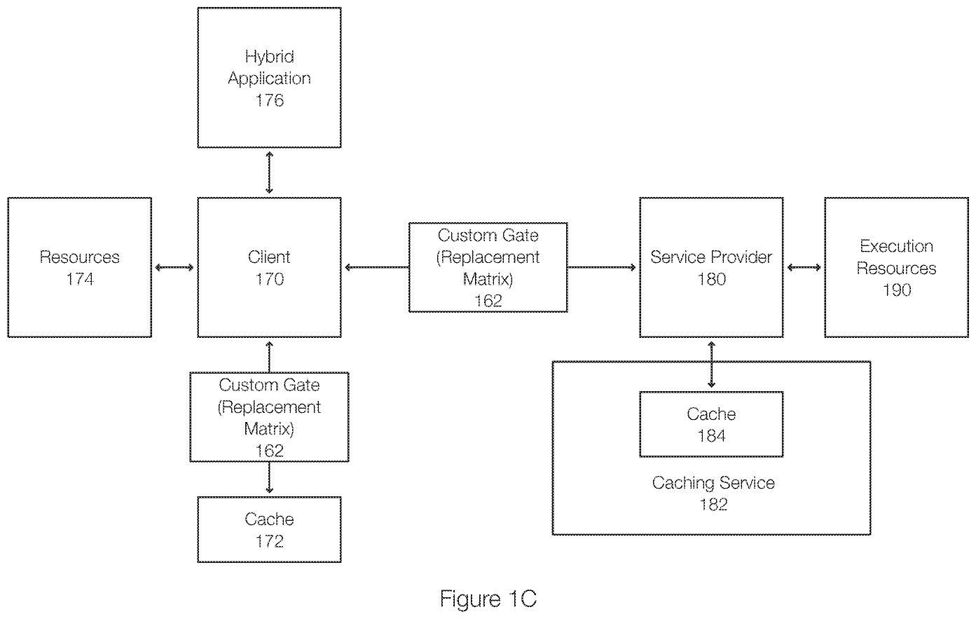

FIG. 1A discloses aspects of orchestrating a quantum job. In one example, a quantum job 108 may be generated by a hybrid application 104. The orchestration of the quantum job 108 may be performed by an orchestration engine 110 that includes or has access to execution resources 140, which includes classical computing resources 120 and quantum computing resources 134. The classical computing resources 120 (e.g., servers, nodes, containers, clusters, virtual machines) may include processors, memory, and the like. As previously stated, some aspects of the quantum job 108 may be executed in classical computing systems 120 and other aspects may be executed in quantum computing resources 134 (simulated or real). When quantum computing resources 134 are required, the hybrid application 104 may generate and submit a quantum job 108 to the orchestration engine 110. Results of executing the quantum job may be returned to the client 102 (or the application 104). Other aspects of the hybrid application 104 that do not require quantum computing may be performed in classical computing systems with or without the aid of the orchestration engine. For example, aspects of the quantum job 108 may be performed in local resources 144. This allows a quantum circuit to be executed remotely and/or locally. Thus, aspects or the quantum job 108 may be performed in the local resources 144 and/or in the execution resources 140.

The local resources 144 may include a cache 146 and the execution resources may provide or include a cache 148. Aspects of embodiments of the invention may generate matrix representations, such as a replacement matrix, that correspond to gate sequences. More specifically, the matrices of certain sequences of gates may be combined or computed down to a representative matrix or replacement matrix. This allows those sequences, when present in quantum circuits, to be replaced with the replacement matrix, thereby avoiding the need to perform the matrix related operations that would otherwise be required. The matrix representations or replacement matrix may be cached in the cache 146 and/or the cache 148. This can improve the performance of orchestrating or of executing the quantum job 108.

More specifically, a client 102 (e.g., a computing device that may receive user input) may submit a quantum job 108, which may be associated with service level objectives 106 and a hybrid application 104, to an orchestration engine 110. The orchestration engine 110 is configured to orchestrate the execution of the quantum job 108 in accordance with the service level objectives 106.

The orchestration engine 110 may orchestrate the operations or actions involved in executing the quantum job. The actions or operations orchestrated by the orchestration engine 110 may include circuit cutting/knitting 122 operations, resource optimization 128 operations, hardware selection 124 operation, runtime prediction 130 operations, transpilation 126 operations, caching operations using the cache 148, or the like or combination thereof.

In effect, the orchestration engine 110 may guide the quantum job 108 through a quantum pipeline such that the output of each stage is directed to the input of the next stage.

Once the quantum circuit in the quantum job 108 is prepared for execution, the quantum circuit is deployed to or placed in the quantum computing resources 134, which may be simulated or real. The results of executing the quantum circuit in the quantum computing resources 134 may also be collected by the orchestration engine 110 and returned to the client 102.

When executing the quantum job 108 in a simulated quantum computing system, embodiments of the invention may process the quantum circuit included in the quantum job 108 to reduce the computational complexity, which may improve performance.

In one example, orchestrating the quantum job 108 may include transforming each gate of the quantum circuit into a matrix of an appropriate size.

During execution, matrix multiplication may be performed. Embodiments of the invention may identify a sequence of gates that repeats in different locations of the quantum circuit and/or which may be associated with different qubits. The sequence of gates may be represented as a sequence of matrix related operations. These operations are performed to generate a resultant matrix, which may be referred to as a replacement matrix. The replacement matrix is an example of a custom gate that represents a sequence of gates in the quantum circuit.

Embodiments of the invention may compute the sequence of gates (or the matrix related operations) a single time and then use the resultant or replacement matrix in the other locations rather than recompute the sequence of matrices each time. This reduces computational requirements and improves execution times. Further, the resultant or replacement matrix may be cached in the cache 146 and/or in a cache 148 in the execution resources 140 such that the replacement matrix is available when executing the quantum circuit in the quantum job 108.

By caching the replacement matrix, the replacement matrix can be used in other quantum circuits that include the same sequence of gates. The cache 146 or 148, in addition to storing the replacement matrix, may also store sufficient information (e.g., number of qubits, gate sequence) that allows the replacement matrix to be used for other quantum circuits.

The replacement matrix is described in the context of an orchestration system configured to orchestrate a quantum job. However, caching a replacement matrix may also be provided as a service on a smaller scale. For example, a quantum provider may allow a user to cache replacement matrices. Alternatively, the user may cache the replacement matrices locally. This may allow circuits to be executed faster as the replacement matrix can be substituted for a sequence of gates and the corresponding matrix operations are avoided.

Prior to discussing a caching service, FIG. 1B discloses an example of a replacement matrix or of a custom gate. FIG. 1B illustrates a quantum circuit 150 that includes multiple gates. In this example, the quantum circuit 150 includes quantum gates 152 and 160. The quantum circuit 150 also includes a sequence 154 of gates that may repeat in the quantum circuit 150. Thus, the sequence 154 may occur in one or both of the quantum gates 152 and the quantum gates 160.

In this example, the sequence 154 of gates, which may include by way of example a T gate 156 and an S gate 158, are computed 164 (e.g., the matrix operations are performed). The result of the computation is a custom gate or replacement matrix 162. In other words, the sequence 154, which may occur at multiple locations in the quantum circuit 150, may be replaced with the custom gate or replacement matrix 162. This allows the computations of the gates 156 and 158 to be performed a single time for all locations of the sequence 154 in the quantum circuit 150.

FIG. 1C discloses aspects of providing a caching service related to simulated or real quantum computing systems. The caching service 182 allows a custom gate or a replacement matrix 162 to be cached. FIG. 1C illustrates a client 170, which may be a classical computing system that includes or is associated with resources 174 (e.g., processors, memory, and the like) may be configured to execute a hybrid application 176. The client 170 itself or the resources 174 may include a cache 172 that is configured to store data related to the execution of quantum jobs including, more specifically, quantum circuits.

In one example, a user may construct a quantum circuit by arranging gates as needed, such as the quantum circuit 150 illustrated in FIG. 1B. In some examples, a user may define a custom gate 162 as illustrated in FIG. 1B. The custom gate may represent a sequence of gates.

Embodiments of the invention identify sequences of gates that repeat, such as the sequence 154 and generate a custom gate or replacement matrix such as the custom gate 162. Thus, the custom gate or replacement matrix 162 represents a sequence of gates whose matrices have been computed. In other words, the custom gate or replacement matrix 162 is generated by computing the matrices associated with the sequence of gates 154 being replaced by the replacement matrix 162.

In this example, a service provider 180, which may be associated with execution resources 190 that may include classical computing resources, simulated quantum systems, and/or real quantum systems, may provide a caching service 182 that includes a cache 184. The client 170 may cache the custom gate 162 (the replacement matrix) or the like in the cache 184 using the caching service 182 and/or in the cache 172, which may be local to the client 170. When caching the custom gate 162, additional metadata may be cached such as number of qubits, corresponding gates being replaced, or the like.

Caching the custom gate 162 may allow the client 170 to conserve costs as less quantum resources/quantum time are required to execute the quantum circuit. Further, the service provider 180 may also manage their resources by using custom gates that are cached in the cache 184. Caching custom gates allows a gate by gate determination of where the gate is applied. This may allow a quantum circuit to be executed at both the execution resources 190 and the resources 174 because the replacement gate can reduce computing requirements that would otherwise be required. In other words, the location at which a quantum circuit may change from one gate to the next.

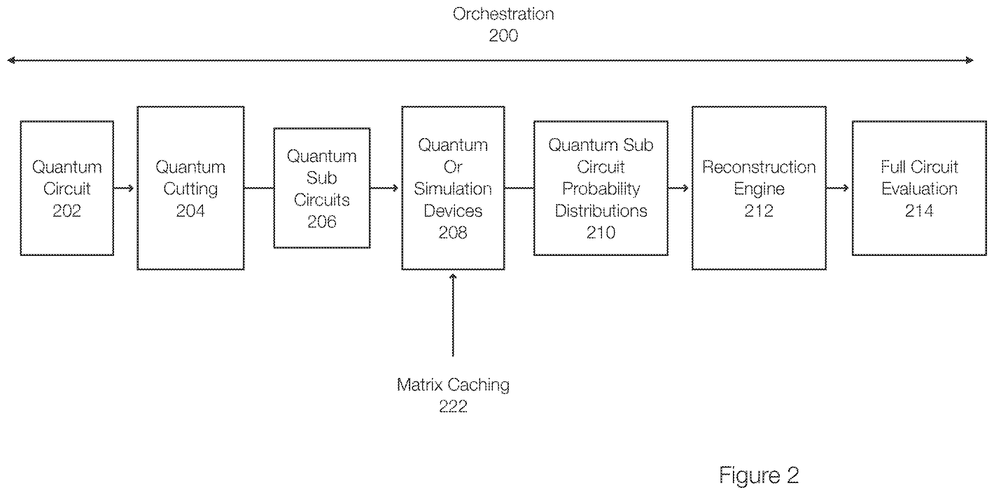

FIG. 2 discloses aspects of orchestrating the execution of a quantum circuit and illustrates examples of orchestration actions or operations. In FIG. 2, an orchestration engine performs orchestration 200 that may begin with receipt of a quantum job or circuit and end with providing results of executing the quantum circuit. As shown in FIG. 2, a quantum circuit 202 is provided to quantum cutting 204 (not all quantum circuits require cutting). After cutting 204 the quantum circuit, quantum subcircuits 206 are generated and submitted to quantum or simulation devices 208 (e.g., QPUs or vQPUs).

During the process of preparing the quantum circuit (or the quantum subcircuits 206) for execution, matrix related actions or operations, such as matrix caching 222, may be performed. An analysis of the gates in the quantum subcircuits 206 or their matrix representations may determine that a sequence of gates is repeated. This sequence of gates, which may be represented by or correspond to a sequence of matrices, are computed and represented as a resultant or replacement matrix. The replacement matrix, which is an example of a custom gate, may be cached for use during execution of the quantum subcircuits 206. In other words, the sequence of gates can be replaced with the replacement matrix prior to execution in the quantum simulator. If the replacement matrix is cached, the replacement matrix may be available for other quantum circuit executions that may include the same sequence of gates. A quantum or simulation device may have the ability to recognize that a sequence of gates can be replaced on-the-fly (e.g., when preparing the circuit for execution) with a custom gate that has been cached. This may be useful, for example, when a user defines a custom gate and uses that custom gate in multiple quantum circuits. In a quantum simulator, the replacement matrix may be used during execution and can improve performance and execution time.

Next, a knitting operation (if the quantum circuit was cut) is performed by a reconstruction engine 212. The reconstruction engine 212 combines the outputs (e.g., the various probability distributions 210) of executing the quantum subcircuits 206 to determine the output (the probability distribution) of the original quantum circuit 202. This allows an evaluation 214 of the full or original quantum circuit to be performed. The results or evaluation can be returned to the client or to the hybrid application.

A quantum processing unit or system, such as a quantum simulator, at its core in one example, is a collection of qubits, often in practice the spins of electrons, which are manipulated by quantum gates. These gates are similar to classical CPU gates in that they can flip (qu) bits, and use the state of one qubit to control the state of another qubit, for example in the form of a CNOT gate. However, a qubit is different from a bit in the sense that its state is not just either 0 or 1, but rather some superposition of the two, of which there are (uncountably) infinitely many. From a coding perspective, the information of the state of a qubit requires the use of floats, rather than an integer or Boolean. Manipulating a simulated qubit includes not just deciding whether to flip the qubit or not but deciding what real-number-precise state to flip the qubit to. Quantum simulators do this by using a linear algebra model of quantum mechanics to emulate the actions of a quantum processing unit (QPU). Embodiments of the invention leverage the linear algebra to shorten the quantum simulation by avoiding unnecessary (redundant) matrix computations.

Embodiments of the invention avoid repeated matrix calculations and improve the performance of quantum simulation. Given that the quantum circuit, when interpreted by a simulator, includes building matrices, embodiments of the invention provide mechanisms to avoid redundant matrix related (e.g., matrix-matrix) calculations. If a sequence of gates is repeated, computing the same sequence of gates multiple times will likely result in the same probability distribution (even though each measurement may be different). This allows the sequence of gates to be computed once. The resultant or replacement matrix can then be used to replace the sequences of gates that repeat or their corresponding matrices.

As previously indicated, matrix operations in the context of quantum simulation require substantial memory and compute resources. Quantum simulation cannot be calculated by hand and requires a significant number of matrix operations. The amount of memory to perform these calculations increases exponentially as the quantum circuit size increases. Larger computers, high-performance computing systems, and GPU acceleration can enable the simulation of larger quantum circuits.

In one example, a quantum circuit may be designed that is configured to realize a particular algorithm. A quantum simulator that receives this quantum circuit transforms each of the gates into a matrix of an appropriate size, and then combines the matrix with other matrices using multiplication, or applies them to the input qubit vector one-by-one.

For example, if MQ₁ . . . . MQₖ represents a series of matrices realizing the gates Qᵢ of a quantum circuit, the calculations can be represented in various manners. The following two representations assume that ˜v is an input qubit vector.

$$( M {Q}_{k} \cdot {MQ}_{k - 1} \cdot … \cdot {MQ}_{1} ) \cdot ∼ v = ( {MQ}_{k} ( M {Q}_{k - 1} ( … {MQ}_{1} \cdot ∼ v ) … ) .$$

If a sequence of gates is repeated, the above sequence may be expressed as

$$M {Q}_{k} \cdot … \cdot {( {MQ}_{i} \cdot {MQ}_{i - 1} \cdot {MQ}_{i - 2} )}^{j} \cdot … \cdot {MQ}_{1} ,$$

where (MQᵢ·MQᵢ₋₁·MQᵢ₋₂) is repeated j times.

In this example, embodiments of the invention compute the following replacement matrix:

$$N = M {Q}_{i} \cdot {MQ}_{i - 1} \cdot {MQ}_{i - 2} .$$

Next, the same matrix or vector operation is determined or revised as follows:

$$( M {Q}_{k} \cdot … \cdot {MQ}_{j + 1} \cdot {N}_{j} \cdot … \cdot {MQ}_{1} ) \cdot ∼ v .$$

In effect, the series of gates represented by MQᵢ·MQᵢ₋₁·MQᵢ₋₂ is replaced with a replacement matrix N.

In one embodiment, because N is computed once, (2j-3) matrix-matrix operations are saved or avoided, which improves performance as long as j is at least 2. In general, a sequence of n gates repeated j times will save ((n−1) j−n) matrix-matrix operations. In one example, N is computed and cached such that N is available for execution of the current quantum circuit and/or other quantum circuits.

When generating a quantum circuit, a user may define a custom group of gates, which may include a plurality of individual quantum gates. The custom group may be used at various places in the quantum circuit. The ability to generate a custom group, which may be used at multiple locations in a quantum circuit, prevents a user from having to repeatedly define the custom group and allows the user to change all instances of the custom group more easily. However, a custom group does not conventionally improve performance because the matrix calculations at each location are not avoided.

In one example, embodiments of the invention evaluate a quantum circuit, including custom groups, to determine whether a sequence of gates is repeated. In one example, the custom group may be a viewed as a sequence of gates that repeats in the quantum circuit. When the sequence of gates is repeated in the quantum circuit, computing the sequence of gates will result in the same probability distribution, even in each measurement is different at each execution. Using this uniformity, embodiments of the invention allow a sequence of gates to be computed once and cached. Computing the sequence of gates may generate a custom gate, which may also be referred to as a and may be used as a replacement matrix. Thus, the sequence of gates can be replaced with the replacement gate or matrix and the replacement matrix may be cached. Advantageously, many matrix-matrix calculations are avoided in the quantum circuit. There is no requirement, however, that the custom gate be cached as performance can be improved even when executing a single quantum circuit.

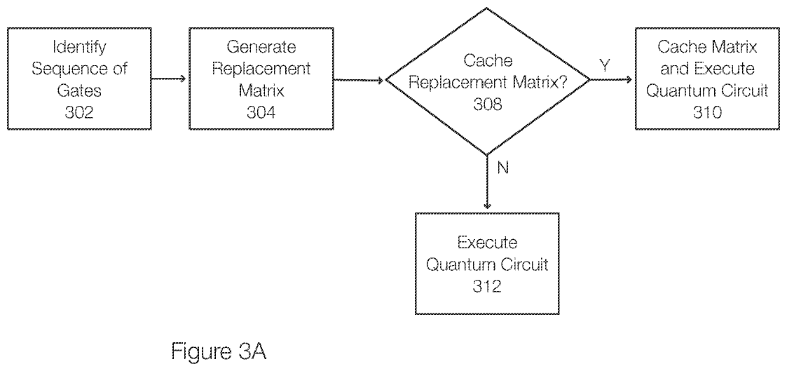

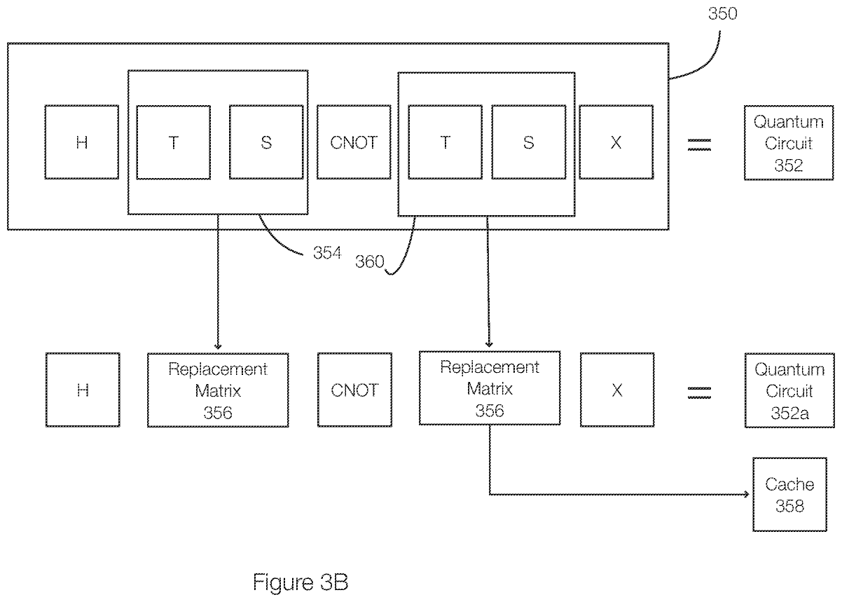

FIG. 3A discloses aspects of replacement matrixes and aspects of caching matrix representations of quantum gates. In FIG. 3A, a sequence of gates 302 is identified or defined by a user. The sequences of gates may repeat in the quantum circuit. After identifying the sequence of gates 302, a replacement matrix 304 (or custom gate) is generated by computing the matrices in the sequence of gates 302. The replacement matrix 304 is configured to take the place of the sequence of gates 302 at each location in the quantum circuit that the sequence of gates 302 appears. If one or more sequences of gates are identified, one or more replacement matrices may be generated: one for each unique sequence of gates.

If a decision is made to cache the replacement matrix (Y at 308), the replacement matrix is cached and the quantum circuit is executed 310. Executing the quantum circuit 310 may include replacing the sequence of gates, at all locations in the quantum circuit, with the replacement matrix. This reduces the number of matrix-matrix operations. The replacement matrix, when cached, is available for use in other quantum circuits.

If the replacement matrix is not cached (N at 308), then the quantum circuit is executed 312 and, in one example, the sequence of gates is replaced with the replacement matrix at all locations in the quantum circuit.

FIG. 3B discloses aspects of caching matrix representations of quantum gates and of reducing the complexity of executing quantum circuits. FIG. 3B illustrates a series of gates 350, which is an example of a quantum circuit 352.

In this example, an evaluation of the series of gates 350 that form the quantum circuit 352 illustrates a sequence of gates 354 that repeats (twice in this example). More specifically, the sequence of gates 360 is the same as the sequence of gates 354 in the quantum circuit 352.

Embodiments of the invention thus compute the matrices of sequence of gates 354. More specifically, the matrices that correspond to the sequence of gates 354 are computed to generate a replacement matrix 356, which is an example of a custom gate. Once the replacement matrix is generated, the sequences of gates 354 and 360 can be replaced in the quantum circuit (illustrated as the quantum circuit 352a) with the replacement matrix 356. Thus, the quantum circuit 352a represents the quantum circuit 352 where sequences of gates 354 and 360 have been replaced with the same replacement matrix 356. During execution of the quantum circuit 352a, the replacement matrix 356 is used. Thus, even though the sequence of gates 354 and 360 occur twice, the corresponding matrix calculations are performed once.

In one example, the replacement matrix 356 is cached in a cache 358, whether local or remote and may be used whenever the sequence of gates 354 is present in a quantum circuit.

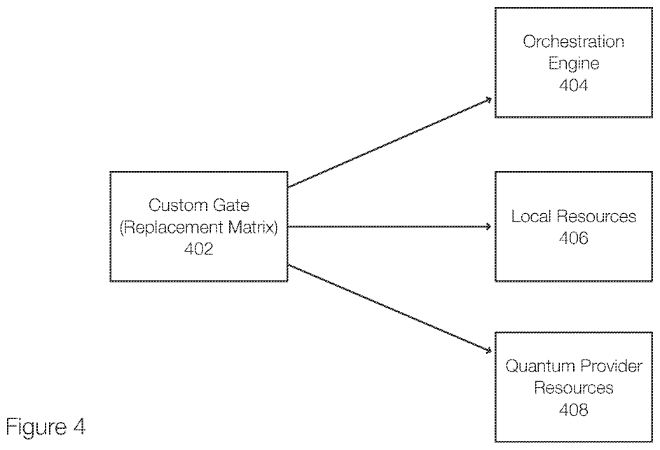

FIG. 4 discloses aspects of caching a gate or a matrix representation of a sequence of gates. FIG. 4 illustrates that a custom gate 402 may be cached by an orchestration engine 404, in local resources 406, and/or resources 408 of a quantum provider. Alternatively, the gate 402 may be cached as a service provided by a quantum provider or locally by a client. Further, it may be possible to cache only the replacement matrix. By caching a custom gate or a replacement matrix for a sequence of gates, the application of where the cached gate or replacement matrix is applied can be determined by a client and/or by a provider and/or by an orchestration engine.

Embodiments of the invention allow users to define and re-use cached resultant matrices that correspond to a sequence of gates. Further, due to the improvement in performance, users have increased control over where the quantum simulation for each gate application in a quantum circuit occurs. Thus, executing a quantum circuit that includes a custom gate can be executed locally, remotely, or both. Thus, as illustrated in FIGS. 3A, 3B, and 4, a user may submit any custom gate or a replacement matrix that represents a sequence of gates, which may be custom, for caching even if that custom gate is not necessarily a logical candidate for caching.

In one example, caching gates or a replacement matrix on a local system such as the local resources 406 can additionally be performed in a remote environment, such as the orchestration engine 404 or the quantum provider resources 408. If executing a quantum circuit requires more compute, memory, or acceleration, than currently available in the local resources 406, a cloud quantum provider could offer this feature (cached replacement matrices or cached sequences of gates that include replacement matrices) as part of a quantum simulation service.

Conventionally, when quantum circuits are submitted to remote quantum simulators, those quantum circuits or portions thereof are not cached to be run again, and custom gates may not be cached. A quantum provider can improve their customer-facing features and save compute by allowing users to define custom gates that could be used in future quantum circuit submissions. The matrix representations of these custom gates (or of the repeating sequences of gates) could be stored in a filesystem or in a memory and can be available for use without having to redefine the entire sequence of gates and without having to compute the matrix operations of the sequence of gates represented by the custom gate.

The provider could additionally offer a hybrid cloud-local (and/or edge) solution that allowed users to perform pieces of their quantum circuit simulation in either environment. Each gate added to a quantum circuit (including custom gates) could optionally be tagged to be applied or executed either in the provider's remote environment (e.g., the quantum provider resources 408) or in the user's local environment (e.g., the local resources 406). As long as the user is able to send and receive the affected subset of the quantum state to and from the provider, gates can be applied either locally or remotely.

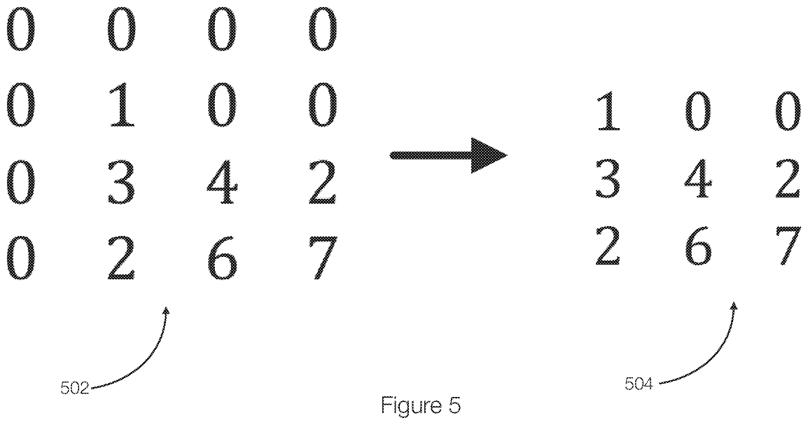

In one example, a matrix representation of a custom gate may be sparse. In one example, many of the qubits are unaffected in a sparse matrix. FIG. 5 discloses aspects of a sparse matrix that represents a custom gate or that represents a replacement matrix. More specifically, a matrix 502 may be an example of a replacement matrix for the matrices associated with a sequence of gates in a quantum circuit. An orchestration engine or a quantum computing system may determine that the matrix 502 is sparse in one example. More specifically, if some of the qubits are unaffected or minimally affected, the matrix 502 can be pared. In this example, the matrix 502 is pared to be the matrix 504. In one example, each qubit that is ignored by paring the matrix 502 essentially halves the size of the matrix because the matrix size is exponentially proportional to the number of qubits. Further, because the size of the matrix 504 is smaller than the gate's definition, the compute operations required to simulate the gate are also significantly reduced, which expedites the time to result for users.

Embodiments of the invention include caching a repeated gate matrix to reduce overall operations. As previously described, the ability to define a custom gate is distinct from caching a matrix representation of a custom gate. More specifically, the ability to add a custom gate in various locations does not remove the requirement of performing the associated matrix-matrix operations. Embodiments of the invention, however, improve performance by replacing identical sequences of gates with a resultant matrix or resultant matrices. Embodiments of the invention allow a gate to be treated as an object that can be evaluated independently and treated or associated with a particular matrix representation.

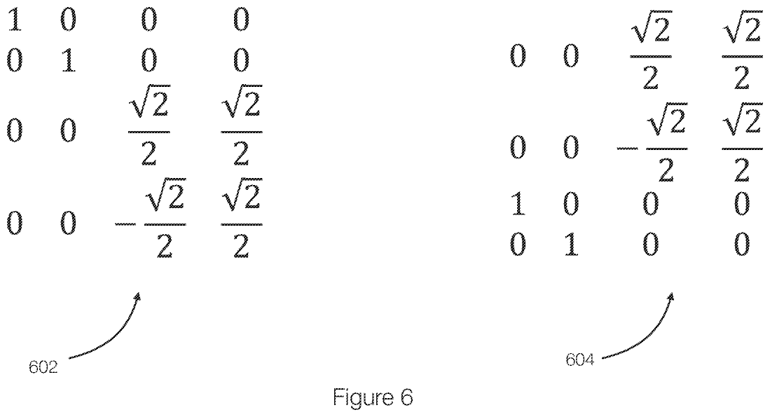

FIG. 6 discloses aspects of applying a gate or a replacement matrix to a different set of qubits or a different order of qubits. In other words, in some embodiments, an identical gate may be applied to a different (or differently ordered) set of qubits.

For example, a Hadamard gate may be applied to the first two of four qubits. This is a different 4×4 matrix than the Hadamard gate applied to the third and fourth qubits, which is illustrated as the matrix 602 in FIG. 6. However, both of these gates are made using the same 2×2 matrix and the 4×4 matrix can be built by essentially applying the correct 2×2 matrix in the right place. The ability to cache the matrix representation of a repeated series of gates not only gives the ability to speed up the application of that gate to that same configuration of qubits, but also to any set of qubits that have the same gate applied in the future, even if they are in a different order. By applying a permutation matrix to the cached matrix 602, it is possible to apply a custom gate (such as the matrix 604, to the same qubits, but in a different order (such as using qubit 2 as the control qubit for a CNOT gate, rather than qubit 1).

Embodiments of the invention allow cloud, edge, and/or local compute environments to be combined for quantum circuit execution, which may include caching operations or matrix caching operations.

In addition to simple remote quantum simulation, embodiments of the invention include remote caching of custom gates and gate-by-gate determination of where that gate or replacement matrix is applied (locally or remotely). This advantageously allows remote quantum simulation services that permits users to define and re-use cached resultant matrices of custom quantum gates. Additionally, embodiments of the invention provide quantum simulation services that allow users to change where computation happens for each gate application in a quantum circuit. These embodiments make more resources flexibly available to users and allow quantum circuits to be creatively simulated.

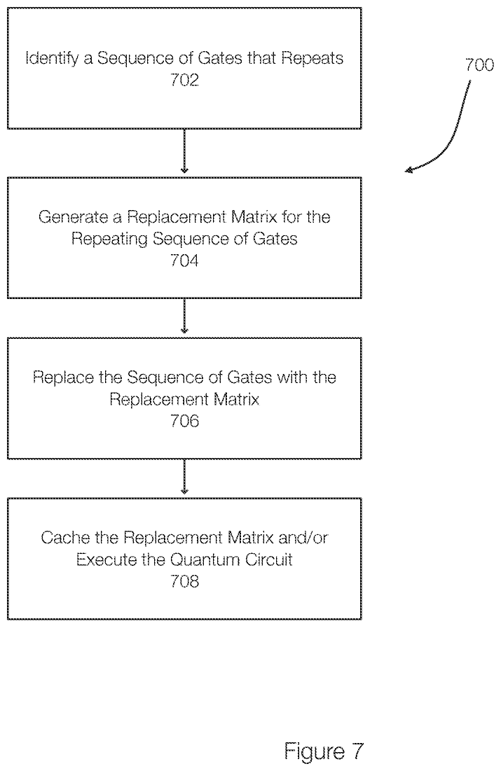

FIG. 7 discloses aspects of executing a quantum circuit in a quantum simulator. The method 700 may include identifying a sequence of gates. In one example, the method include identifying a sequence of gates in a quantum circuit that is repeated multiple times.

Once the sequence of gates, which may repeat, has been identified, the sequence of gates is processed. The repeating sequences of gates do not need to be consecutive, but can be separated. For example, a replacement matrix (custom gate) for the sequence of gates may be generated 704. The replacement matrix (or replacement or custom gate) may be generated by solving or computing a resultant matrix for the gates in the sequence of gates that repeats in the quantum circuit. The sequence of gates is then replaced 706 with the replacement matrix or custom gate. The replacement matrix may be cached 708 locally and/or remotely. Thus, anytime the corresponding sequence of gates occurs in a quantum circuit, the sequence of gates can be replaced with the replacement matrix or custom gate that has been cached.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, hybrid-classical application operations, quantum circuit operations, quantum circuit execution operations, quantum circuit cutting operations, resource consumption estimation operations, quantum circuit knitting operations, telemetry operations, machine learning model operations (e.g., that generate predictions or inferences), modelling operations, recurrent modelling operations; probability related operations, cutting optimization operations, or the like or combination thereof. These operations may, in some examples, be referred to as quantum operations.

Example cloud computing environments, which may or may not be public, include storage environments that may provide functionality for one or more clients or systems. Another example of a cloud computing environment is one in which quantum operations and/or quantum services may be performed on behalf of one or more clients, applications, or users. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment. The cloud environment may also include quantum environments including vQPUs, QPU, other accelerators, or the like.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data or circuits. Such clients may comprise physical machines, containers, or virtual machines (VMs).

Particularly, devices in the operating environment, such as classical components of hybrid classical-quantum systems, may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

It is noted that any operation(s) of any of these methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: identifying a sequence of gates in a quantum circuit that repeats in a series of gates associated with a quantum circuit, generating a replacement matrix for the sequence of gates, replacing each instance of the sequence of gates in the quantum circuit with the replacement matrix, and executing the quantum circuit that includes one or more instances of the replacement matrix.

Embodiment 2. The method of claim 1, further comprising creating a custom gate, wherein the custom gate defines the series of gates that includes the sequence of gates.

Embodiment 3. The method of embodiment 1 and/or 2, further comprising generating the replacement matrix by computing matrices included in the sequence of gates.

Embodiment 4. The method of embodiment 1, 2, and/or 3, further comprising caching the replacement matrix in local resources and/or remotely in execution resources and/or caching the series of gates after replacing the sequence of gates with the replacement matrix.

Embodiment 5. The method of embodiment 1, 2, 3, and/or 4, further comprising executing a portion of the quantum circuit in the local resources and executing a portion of the quantum circuit in the execution resources associated with a quantum provider.

Embodiment 6. The method of embodiment 1, 2, 3, 4, and/or 5, further comprising replacing a sequence of gates in a second quantum circuit with the replacement matrix.

Embodiment 7. The method of embodiment 1, 2, 3, 4, 5, and/or 6, further comprising paring the replacement matrix.

Embodiment 8. The method of embodiment 1, 2, 3, 4, 5, 6, and/or 7, further comprising applying a permutation matrix to the replacement matrix and using a resultant matrix with qubits in a different order.

Embodiment 9. The method of embodiment 1, 2, 3, 4, 5, 6, 7, and/or 8, wherein the replacement matrix is computed a single time and wherein the replacement matrix is configured to reduce a number of matrix-matrix operations.

Embodiment 10. The method of embodiment 1, 2, 3, 4, 5, 6, 7, 8, and/or 9, further comprising storing the replacement matrix in a cache and associating the replacement matrix with the sequence of gates.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

Embodiment 13. A system comprising a processor and memory configured to perform the operations, methods, or processes, or any portion of any of these, or any combination thereof disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, or agent, may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, herein, may take the form of, or include, or be implemented on, or hosted by, a physical computing device, As well, where any of the aforementioned elements comprise or consist of a virtual machine (VM) or a container, that VM or container may constitute a virtualization of any combination of the physical components disclosed herein.

In a physical computing device includes a memory which may include one, some, or all, of random-access memory (RAM), non-volatile memory (NVM) such as NVRAM for example, read-only memory (ROM), and persistent memory, one or more hardware processors, non-transitory storage media, Ul device, and data storage. One or more of the memory components of the physical computing device may take the form of solid-state device (SSD) storage. As well, one or more applications may be provided that comprise instructions executable by one or more hardware processors to perform any of the operations, or portions thereof, disclosed herein. The physical device may be an example of a classical computing system that may be part of a hybrid computing system. A quantum processing system or unit may also be included in the hybrid computing system.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
identifying a sequence of gates in a quantum circuit that repeats in a series of gates associated with a quantum circuit;
generating a replacement matrix for the sequence of gates;
replacing each instance of the sequence of gates in the quantum circuit with the replacement matrix; and
executing the quantum circuit that includes one or more instances of the replacement matrix.

2. The method of claim 1, further comprising creating a custom gate, wherein the custom gate defines the series of gates that includes the sequence of gates.

3. The method of claim 1, further comprising generating the replacement matrix by computing matrices included in the sequence of gates.

4. The method of claim 1, further comprising caching the replacement matrix in local resources and/or remotely in execution resources and/or caching the series of gates after replacing the sequence of gates with the replacement matrix.

5. The method of claim 4, further comprising executing a portion of the quantum circuit in the local resources and executing a portion of the quantum circuit in the execution resources associated with a quantum provider.

6. The method of claim 5, further comprising replacing a sequence of gates in a second quantum circuit with the replacement matrix.

7. The method of claim 1, further comprising paring the replacement matrix.

8. The method of claim 1, further comprising applying a permutation matrix to the replacement matrix and using a resultant matrix with qubits in a different order.

9. The method of claim 1, wherein the replacement matrix is computed a single time and wherein the replacement matrix is configured to reduce a number of matrix-matrix operations.

10. The method of claim 1, further comprising storing the replacement matrix in a cache and associating the replacement matrix with the sequence of gates.

11. A non-transitory storage medium having stored therein instructions that are executable by one or more hardware processors to perform operations comprising:
identifying a sequence of gates in a quantum circuit that repeats in a series of gates associated with a quantum circuit;
generating a replacement matrix for the sequence of gates;
replacing each instance of the sequence of gates in the quantum circuit with the replacement matrix; and
executing the quantum circuit that includes one or more instances of the replacement matrix.

12. The non-transitory storage medium of claim 11, further comprising creating a custom gate, wherein the custom gate defines the series of gates that includes the sequence of gates.

13. The non-transitory storage medium of claim 11, further comprising generating the replacement matrix by computing matrices included in the sequence of gates.

14. The non-transitory storage medium of claim 11, further comprising caching the replacement matrix in local resources and/or remotely in execution resources and/or caching the series of gates after replacing the sequence of gates with the replacement matrix.

15. The non-transitory storage medium of claim 14, further comprising executing a portion of the quantum circuit in the local resources and executing a portion of the quantum circuit in the execution resources associated with a quantum provider.

16. The non-transitory storage medium of claim 15, further comprising replacing a sequence of gates in a second quantum circuit with the replacement matrix.

17. The non-transitory storage medium of claim 11, further comprising paring the replacement matrix.

18. The non-transitory storage medium of claim 11, further comprising applying a permutation matrix to the replacement matrix and using a resultant matrix with qubits in a different order.

19. The non-transitory storage medium of claim 11, wherein the replacement matrix is computed a single time and wherein the replacement matrix is configured to reduce a number of matrix-matrix operations.

20. The non-transitory storage medium of claim 11, further comprising storing the replacement matrix in a cache and associating the replacement matrix with the sequence of gates.
